(19) United States
(12) Patent Application Publication
(10) Pub. No.: US 2005/0155644 A1
(43) Pub. Date: Jul. 21, 2005

(54) Natural gas odorant injection system

(75) Inventor: David E. Woollums, Frisco, TX (US)

Correspondence Address: MARSHALL, GERSTEIN & BORUN LLP (FISHER), 233 SOUTH WACKER DRIVE, 6300 SEARS TOWER, CHICAGO, IL, 60606, US

(73) Assignee: FISHER CONTROLS INTERNATIONAL LLC, St. Louis, MO (US)

(21) Appl. No.: 11/038,558

(22) Filed: Jan. 18, 2005

Related U.S. Application Data
(60) Provisional application No. 60/537,572, filed on Jan. 20, 2004.

(51) Int. Cl. E03B 1/00; F17D 3/00

(52) U.S. Cl. 137/3

(57) ABSTRACT

A natural gas odorant injection system for injecting odorant into a main gas line includes a by-pass line, an odorant tank, a flowmeter, a control valve, and a controller communicably coupled to the flowmeter and the control valve. The by-pass line includes an inlet that is in fluid communication with an upstream section of the main gas line, and an outlet that is in fluid communication with a downstream section of the main gas line. The odorant tank, the control valve, and the flowmeter are disposed in the by-pass line. The flowmeter senses a characteristic of a fluid flow through the flowmeter and, accordingly, generates a fluid flow signal. The controller is programmed to operate the control valve based on the fluid flow signal received from the flowmeter.

### RELATED APPLICATION DATA

The present application is a non-provisional application based on, and claiming the priority benefit of, co-pending U.S. provisional application Ser. No. 60/537,572, which was filed on Jan. 20, 2004, and is expressly incorporated by reference herein.

### FIELD OF THE DISCLOSURE

The present disclosure generally relates to gas odorant injection systems and, more specifically, to natural gas odorant injection systems using flowmeter controls.

### BACKGROUND OF THE DISCLOSURE

Traditional natural gas odorant injection systems have used small by-pass systems for low natural gas flow demand applications, and pump based systems for high flow rate applications. The advantage of by-pass systems is that they are inexpensive. Their disadvantage is they have limited rangeability, resulting in under odorization if natural gas flow rates increase significantly or over odorization if they decrease significantly. By-pass systems also require a pressure drop in the pipeline, such as a control valve, regulator, or other pressure reduction station to operate, as well as pressurization of the odorant storage tank. Pump based systems have somewhat higher rangeability and do not require a pressure differential or pressurized storage tanks for operation, but are much more expensive and tend to have reliability issues. As a result, a by-pass system is used in low flow and lower pressure applications where installation cost is an issue. Pumps are used in high flow and high-pressure applications where control of odorant injection rates are critical and the costs for large high-pressure storage tanks offset the higher costs of the pump system.

Natural gas odorant injection systems having a pressure injection mechanism have been recently introduced that provide an alternative for intermediate and low flow/pressure applications. Like the by-pass systems, they require a pressure differential and a pressurized storage tank to operate. This is a disadvantage over pump based systems for very high-pressure transmission applications. Pressure injection systems utilize solenoid valves to control injection rates. Both the duration of valve opening and the dwell time between openings can be controlled. This results in unmatched rangeability, a key advantage over both pump and by-pass systems. Solenoid valves are also inherently more reliable than pumps. By-pass systems, however, still have a niche for very small flow applications due their low cost.

A key issue with pressure injection systems is that they utilize a calibrated cylinder to monitor injection rates and recalibrate solenoid timing. This results in a somewhat large and complex system. It also requires release of a small amount of highly odorant-saturated natural gas to atmosphere every time the calibration/injection cylinder is refilled.

### BRIEF DESCRIPTION OF THE DRAWINGS

FIG. 1 is a schematic diagram of a natural gas odorant injection system constructed in accordance with one example of the teachings of the present disclosure;

FIG. 2 is a schematic diagram of another example of a natural gas odorant injection system;

FIG. 3 is a schematic diagram of one example of a tank used in the natural gas odorant injection system of FIG. 2;

FIG. 4 is a schematic diagram of another example of a tank used in the natural gas odorant injection system of FIG. 2;

FIG. 5 is a schematic diagram of one example of a controller as used in the natural gas odorant injection system of FIG. 2;

FIG. 6 is a schematic diagram of another example of a natural gas odorant injection system;

FIG. 7 is a schematic diagram of yet another example of a natural gas odorant injection system; and

FIG. 8 is a flowchart of one example of an operation of the natural gas odorant injection system of FIG. 2.

While the method and device described herein are susceptible to various modifications and alternative constructions, certain illustrative embodiments thereof have been shown in the drawings and will be described below in detail. It should be understood, however, that there is no intention to limit the invention to the specific forms disclosed, but on the contrary, the intention is to cover all modifications, alternative constructions, and equivalents falling within the spirit and scope of the disclosure and the appended claims.

### DETAILED DESCRIPTION

A natural gas odorant injection system, as described below, is generally utilized to add odor to otherwise odorless natural gas. Basically, the odorizing of the natural gas may be accomplished by by-passing the odorless natural gas from a main gas line, and then odorizing the gas via a liquid odorant and/or using the odorless natural gas to pressurize an odorant, thereby injecting the odorized gas and/or odorant back into the main gas line.

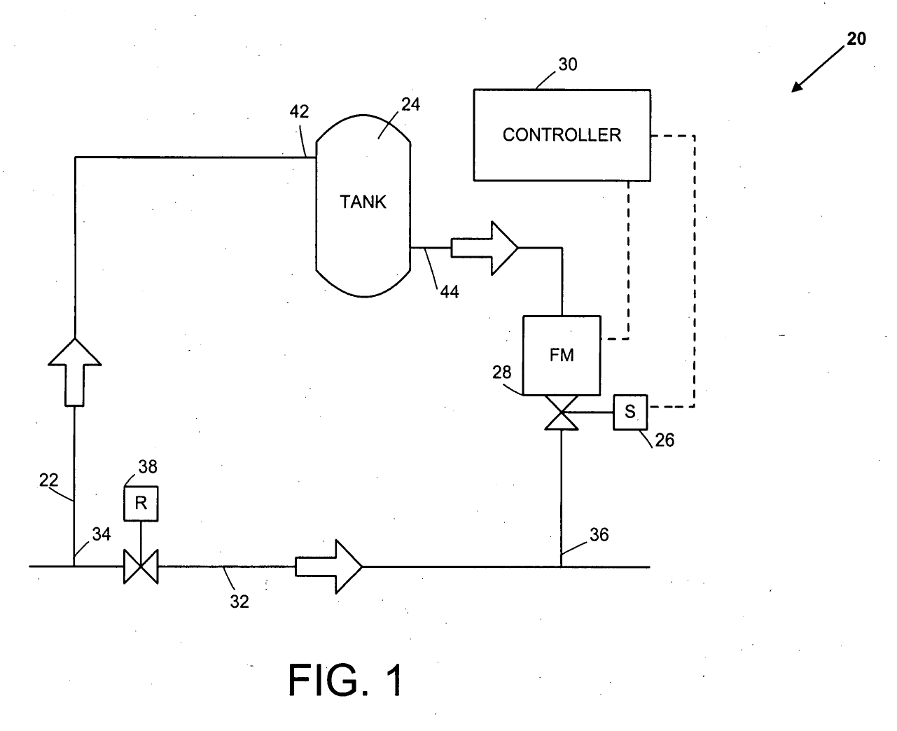

Referring now to the drawings and with specific reference to FIG. 1, a natural gas odorant injection system as constructed in accordance with the teachings of the disclosure is generally depicted by reference numeral 20. As shown therein, the natural gas odorant injection system 20 in one exemplary embodiment includes a by-pass line 22 including a tank 24, a control valve 26, a first flowmeter 28, and a controller 30.

As seen in FIG. 1, the by-pass line 22 may be fluidly connected to a main gas line 32 at an inlet 34 of the by-pass line 22, and may reenter the main gas line 32 at an outlet 36 of the by-pass line 22. The main gas line 32, at the inlet 34, contains odorless natural gas having a pressure that may be in the range of 60 psi to 1500 psi. For reasons of brevity and clarity, however, the natural gas odorant injection system 20 will herein be described as operating in an environment wherein the non-odorized main gas line pressure at the inlet 34 is approximately 500 psi.

To ensure that the odorized gas and/or the odorant can be injected into the main gas line 32 at the outlet 36 of the by-pass line 22, the pressure of the by-pass line 22 at the outlet 36 must be more than the pressure in the main gas line 32 at the outlet 36. This differential pressure between the main gas line 32 and the by-pass line 22 may be accomplished in several ways. For example, as seen in FIG. 1, the pressure of the main gas line 32 may be reduced between the inlet 34 of the by-pass line 22 and the outlet 36 of the by-pass line 22 by a regulator 38. The regulator 38 may include, but is not limited to, a differential pressure regulator and a constant pressure regulator, and may be any type of regulator able to reduce a first pressure to a second pressure. In this exemplary embodiment, the regulator 38 may be a constant pressure regulator set at approximately 300 psi, such that the pressure of the main gas line 32, after the regulator 38, is approximately 300 psi. As such, the pressure of the by-pass line 22 at the outlet 36 may be approximately 500 psi and the pressure in the main gas line 32 at the outlet 36 would be approximately 300 psi, thereby ensuring that a proper differential pressure is created and that the odorized gas and/or the odorant can be injected from the outlet 36 into the main gas line 32.

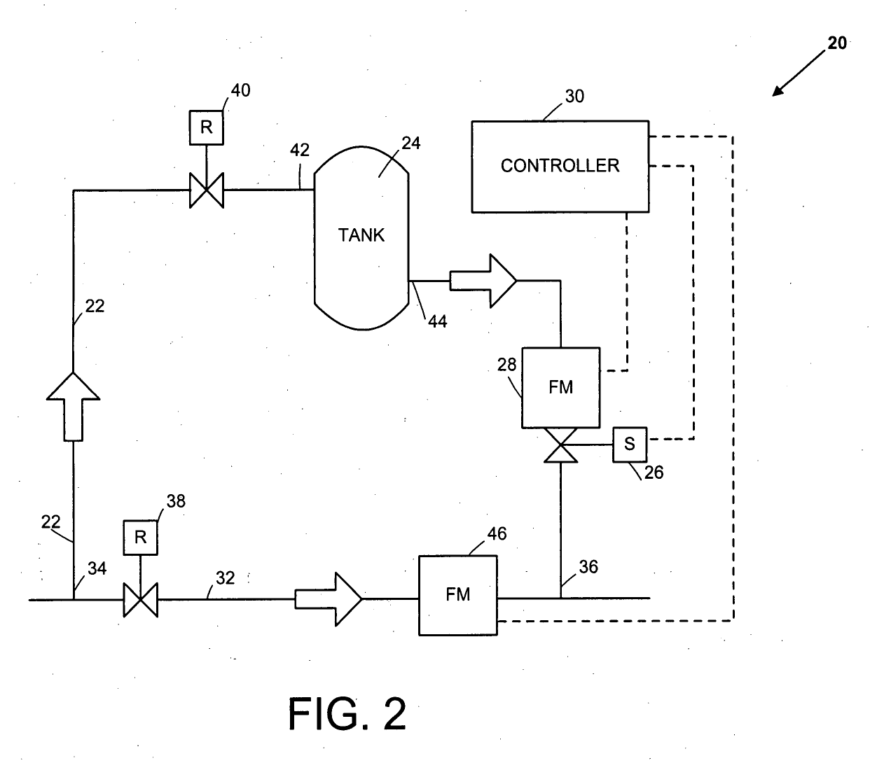

Alternatively, in another exemplary embodiment, as seen in FIG. 2, the by-pass line may undergo a pressure change as well as the main gas line 32, and more specifically, may undergo a pressure reduction. For example, as seen in FIG. 2, a regulator 40 may be disposed in the by-pass line 22 between the inlet 34 and the outlet 36. The regulator 40 may be substantially similar to the regulator 38, or may be any other type of regulator able to reduce a first pressure to a second pressure. In this exemplary embodiment, the regulator 40 may be a constant pressure regulator set at approximately 400 psi, such that the pressure of the by-pass line 22, after the regulator 40, is approximately 400 psi. As such, the pressure of the by-pass line 22 at the outlet 36 may be approximately 400 psi and the pressure in the main gas line 32 at the outlet 36 would be approximately 300 psi, thereby ensuring that a proper differential pressure is created and that the odorized gas and/or the odorant can be injected from the outlet 36 into the main gas line 32.

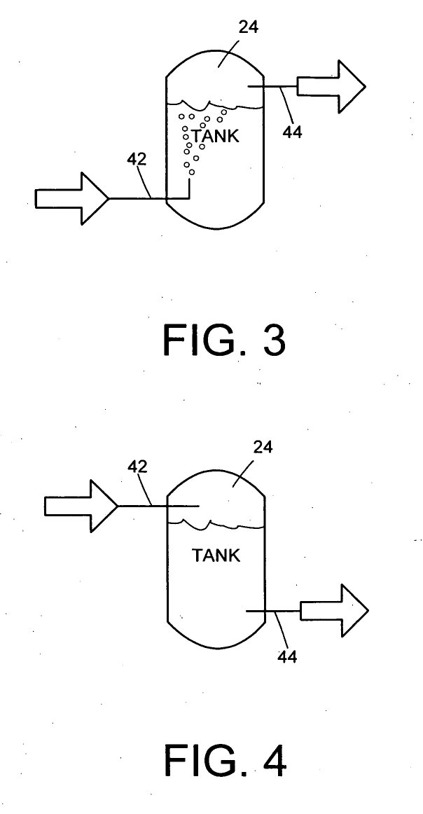

The tank 24, as seen in FIGS. 1, 2, 3, and 4, contains the odorant which may, as in this exemplary embodiment, be stored in liquid form to odorize the natural gas. More specifically, as seen in FIG. 3, the odorless gas may enter the tank 24 at an inlet 42 and become saturated with odorant by bubbling through the odorant, or otherwise becoming saturated, and then exit the tank 24 at an outlet 44 as odorized gas. Alternatively, as seen in FIG. 4, the odorless gas may enter the tank 24 at an inlet 42 thereby causing a pressure in the tank 24. The pressure of the odorless gas in the tank 24 may cause the odorant to exit the tank 24, without gas, at an outlet 44. The state of the odorant leaving the tank 24 at the outlet 44 may, however, be a combination of the above embodiments. For example, the odorant leaving the tank 24 may be entirely gaseous, entirely liquid, or a mixture thereof. As such, the odorant leaving the tank 24 at the outlet 44 may be part gas and part liquid.

Returning to FIG. 2, the odorant, prior to reentering the main gas line 32, may travel though the control valve 26 and the flowmeter 28. The control valve 26, may be any type of valve able to regulate the flow of fluid, whether in liquid and/or in gaseous form. For example, the control valve 26 may be a solenoid valve able to open and close for specific periods of time, or may be able to open and close incrementally. Furthermore, as in this exemplary embodiment, the control valve 26 may be communicably coupled to the controller 30, and more specifically, may be communicably coupled via a hard wire and/or wireless technology.

The flowmeter 28 may be any type of flowmeter able to meter the flowrate of the fluid, whether in liquid and/or gaseous form. For example, the flowmeter 28 may be one of many types of flowmeters, including but not limited to, a coriolis, a vortex, a turbine, a variable area, an electromagnetic, and an ultrasonic type flowmeter. Depending on the type of flowmeter that is used, one or more variables of the fluid may be measured. In this exemplary embodiment, the coriolis type flowmeter 28 measures the mass of the liquid odorant as it passes through the flowmeter 28. More specifically, the flowmeter 28 measures the flow of the odorant by analyzing changes in a Coriolis force of the odorant. The Coriolis force is generated in a mass which is moving within a rotating frame of reference. That rotation produces an angular, outward acceleration, which is factored with linear velocity to define the Coriolis force. With the mass of the odorant, the Coriolis force is proportional to the mass flowrate of that fluid. Furthermore, the flowmeter 28 may be communicably coupled to the controller 30, and more specifically, may be communicably coupled via a hard wire and/or wireless technology.

A second flowmeter 46, as seen in FIG. 2, may be located between the inlet 34 of the by-pass line 22 and/or the first regulator 38, and the outlet 36 of the by-pass line 22. The second flowmeter 46, like the flowmeter 28, may be one of many types of flowmeters, including but not limited to, a coriolis, a vortex, a turbine, a variable area, an electromagnetic, and an ultrasonic type flowmeter. Depending on the type of flowmeter that is used, one or more variables of the fluid may be measured. In this exemplary embodiment, the flowmeter 46 measures the volumetric flowrate of the unodorized natural gas flowing through the flowmeter 46.

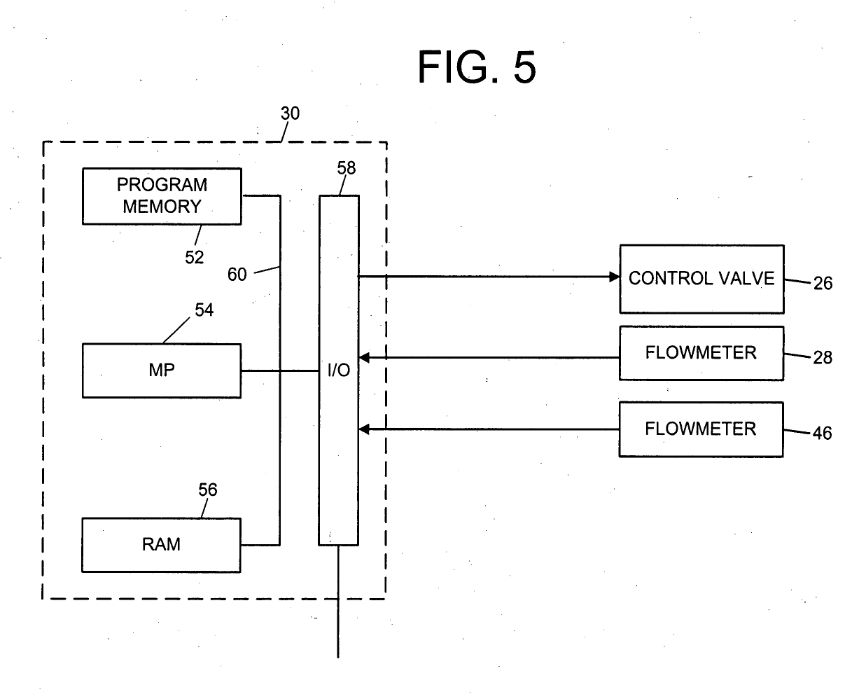

The controller 30, as seen in FIG. 5, may comprise a program memory 52, a microcontroller or microprocessor (MP) 54, a random-access memory (RAM) 56, and an input/output (I/O) circuit 58, all of which may be interconnected via an address/data bus 60. It should be appreciated that although only one microprocessor 54 is shown, the controller 30 may include additional microprocessors. Similarly, the memory of the controller 30 may include multiple RAMs 56 and multiple program memories 52. Although the I/O circuit 58 is shown as a single block, it should be appreciated that the I/O circuit 58 may include a number of different types of I/O circuits.

Additionally and/or alternatively, the controller 30 may be a programmable Logic Controller (“PLC”) or any other type of mechanical and/or electrical device able to activate, deactivate and/or control the control valve 26, the first flowmeter 28, and/or the second flowmeter 46.

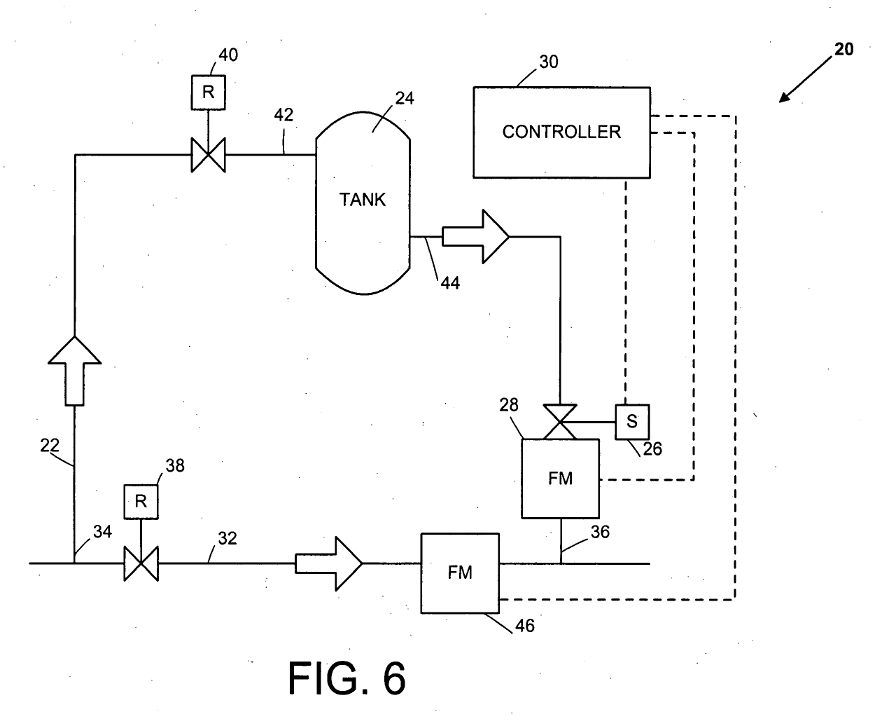

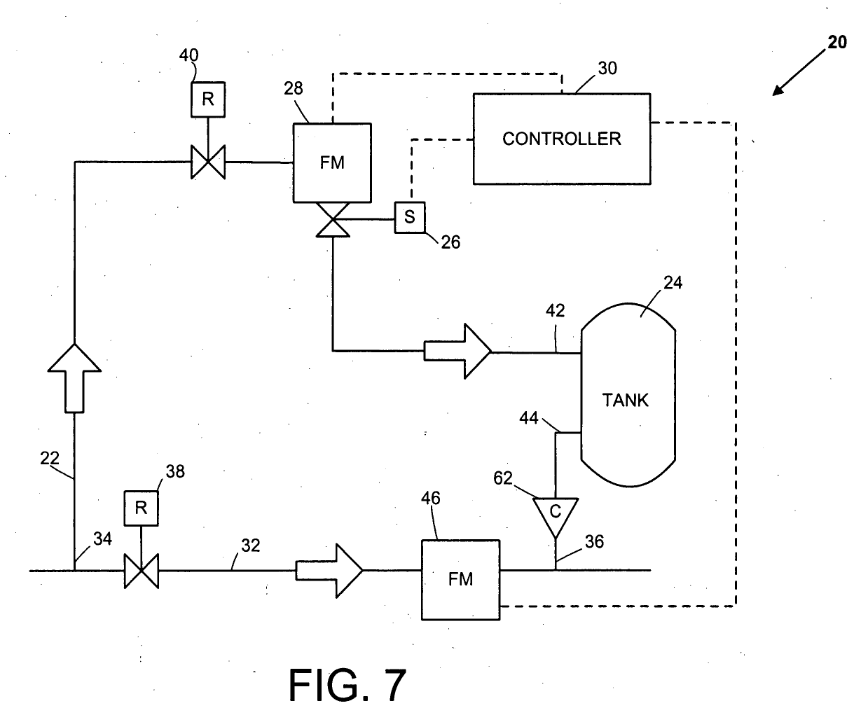

The above exemplary embodiments may include many variations thereof to achieve and/or create additional or alternative features. For example, the location of the various components in the natural gas odorant injection system 20 may be changed and/or altered. For example, the regulator 40 may be positioned before or after the tank 24, and similarly, the flowmeter 28 and/or the control valve 26 may be positioned before or after the tank 24, as seen in FIG. 7. The control valve 26 also need not be located after the flowmeter 28 in the line of flow of the fluid, but may be located anywhere before the flowmeter 28, as seen in FIG. 6. The natural gas odorant injection system 20 may also include additional components such as one or more check valves 62 (FIG. 7) located along the by-pass line 22. As seen in FIG. 7, a check valve 62 may be located between the control valve 26 and the outlet 36 of the by-pass line 22, thereby preventing the unodorized gas from the main gas line 32 from entering the by-pass line 22 through the outlet 36 of the by-pass line 22.

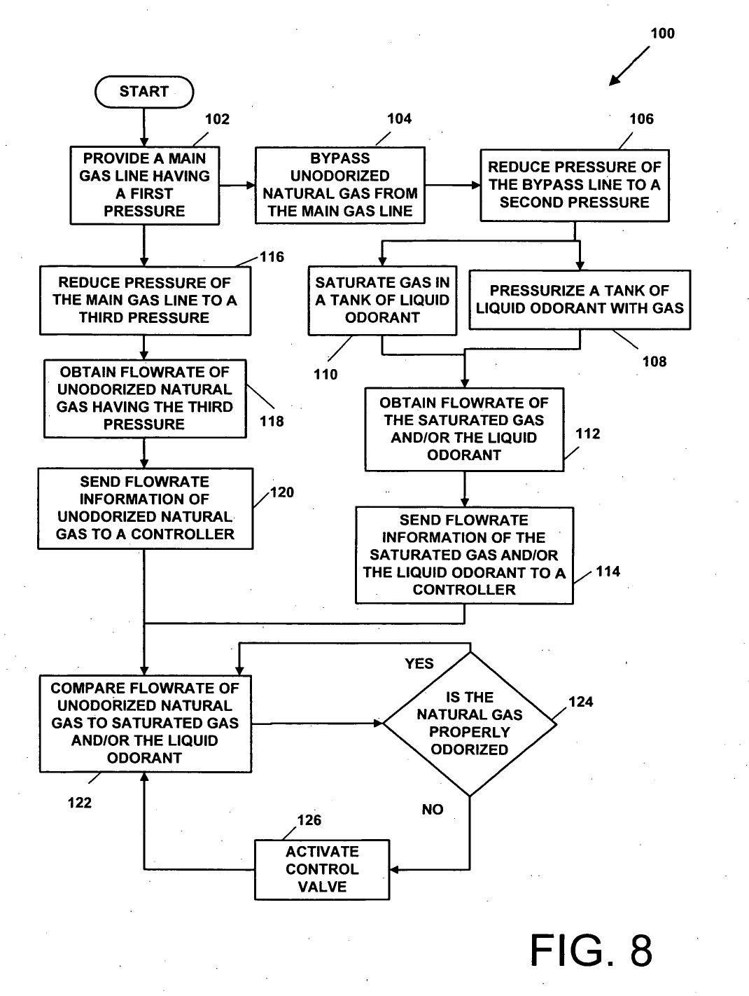

A method for operating the natural gas odorant injection system 20 is illustrated by the flowchart in FIG. 8. An operation 100 of such an exemplary embodiment may begin at block 102 by providing a main gas line 32 that holds unodorized natural gas having a first pressure. At block 104, the unodorized natural gas from the main gas line 32 may be by-passed at an inlet 34 into a by-pass line 22 and control may be passed to block 106. At block 106, the pressure of the by-pass line may be reduced to a second pressure by a regulator 40 or the like. At block 108, the natural gas may enter a tank 24 of odorant, thereby pressurizing the tank 24 and forcing the odorant from the tank 24 toward an outlet 36 of the by-pass line 22. Alternatively and/or additionally, at block 110 the natural gas may enter the tank 24 and become saturated with odorant, which is then forced from the tank 24 toward the outlet 36 of the by-pass line 22. At block 112, a flowrate of the odorant from block 108 and/or the flowrate of the saturated gas from block 110 may be obtained, and control may be passed to block 114. At block 114, the flowrate obtained at bock 112 may be sent to a controller 30, and control may pass to block 122.

At block 116, the unodorized natural gas in the main gas line 32 may be reduced to a third pressure that is less than the second pressure by a regulator 38, or the like. At block 118, a flowrate of the unodorized gas from block 102 and/or block 116 may be obtained, and control may be passed to block 120. At block 120, the flowrate obtained at block 118 may be sent to the controller 30, and control may pass to block 122.

At block 122, the controller 30 may compare the information obtained at block 122 and block 120, and more specifically, may compare the flowrate of the natural gas obtained at block 118 to the flowrate of the odorant and/or the flowrate of the saturated gas obtained at block 112. In this exemplary embodiment, the flowrate obtained at block 118 may be 1,000,000 scfh and the flowrate obtained at block 112 may be 1 lb/hr. Control may then pass to block 123, where the flowrates are analyzed by the controller 30 to determine whether the natural gas in the main line 32 is being odorized properly by the odorant in the by-pass line 22. For example, if the controller 30 is programmed to obtain an odorized gas having 1 pound part per million (ppm) of liquid odorant per 1,000,000 standard cubic feet of natural gas, the controller may determine at decision diamond 124 that the ratios or flowrates obtained at block 118 and block 112 properly odorize the natural gas in the main line 32, and no action will be taken by the controller 30. Control may then pass to block 122.

If, however, the flowrate obtained at block 118 is 2,000,000 scfh, and the flowrate obtained at block 112 is 1 lb/hr, the controller 30 may determine at decision diamond 124 that the ratio or flowrate obtained at block 118 is too great compared to the flowrate at block 112. As such, the controller 30, at decision diamond 124 may pass control to block 126, thereby causing the control valve 26 to open or open more to achieve the 1 pound part per million (ppm) of liquid odorant per 1,000,000 standard cubic feet of natural gas. Control may then pass to block 122.

Similarly, if the flowrate obtained at block 118 is 500,000 scfh, and the flowrate obtained at block 112 is 1 lb/hr, the controller 30 may determine at decision diamond 124 that the ratio or flowrate obtained at block 118 is too low compared to the flowrate at block 112. As such, the controller 30, at decision diamond 124 may pass control to block 126, thereby causing the control valve 26 to close or close more to achieve the 1 pound of liquid odorant per 1,000,000 standard cubic feet of natural gas. Control may then pass to block 122.

While the present disclosure describes specific embodiments, which are intended to be illustrative only and not to be limiting of the disclosure, it will be apparent to those of ordinary skill in the art that changes, additions or deletions may be made to the disclosed embodiments without departing from the spirit and scope of the disclosure.

1. A natural gas odorant injection system for injecting odorant into a main gas line, the injection system comprising:
a by-pass line having an inlet fluidly communicating with an upstream section of the main gas line and an outlet fluidly communicating with a downstream section of the main gas line;
an odorant tank disposed in the by-pass line;
a flowmeter disposed in the by-pass line, the flowmeter sensing a characteristic of fluid flow through the flowmeter and generating a fluid flow signal;
a control valve disposed in the by-pass line; and
a controller communicably coupled to the flowmeter and the control valve, wherein the controller is programmed to operate the control valve based on the fluid flow signal received from the flowmeter.

2. The natural gas odorant injection system of claim 1, wherein the flowmeter is a coriolis type flowmeter and the fluid flow signal corresponds to a mass of the fluid flow through the flowmeter.

3. The natural gas odorant injection system of claim 1, wherein the control valve is a solenoid valve.

4. The natural gas odorant injection system of claim 1, wherein the flowmeter and the control valve are an integral unit.

5. The natural gas odorant injection system of claim 1, wherein the control valve is located upstream of the flowmeter in the by-pass line.

6. The natural gas odorant injection system of claim 1, wherein the control valve is located downstream of the flowmeter in the by-pass line.

7. The natural gas odorant injection system of claim 1, wherein a fluid exiting the odorant tank is one of a liquid and gas.

8. The natural gas odorant injection system of claim 1, further comprising a check valve disposed in the by-pass line downstream of the odorant tank.

9. A natural gas odorant injection system for injecting odorant into a main gas line, wherein a first pressure reduction device is disposed in the main gas line to define a first section upstream of the first pressure reduction device and a second section downstream of the first pressure reduction device so that fluid flowing through the main gas line has a first pressure in the first section and a second pressure, lower than the first pressure, in the second section, the system comprising:
a by-pass line having an inlet in fluid communication with the first section of the main gas line and an outlet in fluid communication with the second section of the main gas line;
a second pressure reduction device disposed in the by-pass line so that fluid flowing through the by-pass line has a third pressure downstream of the second pressure reduction device, wherein the third pressure is greater than the second pressure;
an odorant tank disposed in the by-pass line;
a first flowmeter disposed in the by-pass line, the first flowmeter sensing a characteristic of fluid flow through the first flowmeter and generating a by-pass fluid flow signal;
a control valve disposed in the by-pass line; and
a controller communicably coupled to the first flowmeter and the control valve, wherein the controller is programmed to operate the control valve based on the by-pass fluid flow signal received from the first flowmeter.

10. The natural gas odorant injection system of claim 9, wherein the first flowmeter is a coriolis type flowmeter and the fluid flow signal corresponds to a mass of the fluid flow through the flowmeter.

11. The natural gas odorant injection system of claim 9, wherein a fluid exiting the tank is one of a liquid and gas.

12. The natural gas odorant injection system of claim 9, wherein the control valve is located downstream of the tank in the by-pass line.

13. The natural gas odorant injection system of claim 12, further comprising a check valve disposed in the by-pass line downstream of the tank.

14. The natural gas odorant injection system of claim 9, further including a second flowmeter located in the second section of the main gas line, the second flowmeter sensing a characteristic of a fluid flow through the second flowmeter and generating a main fluid flow signal.

15. The natural gas odorant injection system of claim 14, wherein the controller is further communicably coupled to the second flowmeter and is programmed to operate the control valve based on both the main fluid flow signal and the by-pass fluid flow signal.

16. A method of odorizing natural gas, comprising:
reducing a pressure of a main gas flow from a first pressure at a first section to a second pressure at a second section;
diverting the main gas flow at the first section to create a secondary gas flow;
odorizing the secondary gas flow with odorant;
obtaining a flow rate of the odorized secondary gas flow;
communicating the flow rate of the odorized secondary gas flow to a controller; and
controlling the odorized secondary gas flow into the main gas flow at the second section via the controller based on the flow rate of the odorized secondary gas flow.

17. The method of odorizing natural gas of claim 16, further including reducing the pressure of the secondary gas flow from the first pressure to a third pressure greater that the second pressure.

18. The method of odorizing natural gas of claim 16, further including obtaining a flow rate of the main gas flow at the second section.

19. The method of odorizing natural gas of claim 18, further including communicating the flow rate of the main gas flow at the second section to the controller.

20. The method of odorizing natural gas of claim 19, further including controlling the odorized secondary gas flow into the main gas flow at the second section via the controller based on the flow rate of both the odorized secondary gas flow and the main gas flow at the second section.
